(19) United States
(12) Patent Application Publication
(10) Pub. No.: US 2026/0012125 A1
(43) Pub. Date: Jan. 8, 2026

(54) SOLAR MODULE MOUNTING BRACKET FOR MOUNTING RAIL

(71) Applicant: APA SOLAR, LLC, Ridgeville Corners, OH (US)

(72) Inventors: Josh Von Deylen, Bryan, OH (US); Joseph Von Deylen, Whitehouse, OH (US); Shawn Jeremy Ramey, Ney, OH (US); Richard Alan Roth, Archbold, OH (US); Erik Steven Shinabery, Bryan, OH (US)

(21) Appl. No.: 19/260,959

(22) Filed: Jul. 7, 2025

Related U.S. Application Data
(60) Provisional application No. 63/668,046, filed on Jul. 5, 2024.

(51) Int. Cl. H02S 20/32; F16B 7/04

(52) U.S. Cl. CPC H02S 20/32; F16B 7/0493

(57) ABSTRACT

A solar module mounting system includes a solar module bracket comprising a central panel, first side panel, and second side panel that together form a U-shaped configuration defining a channel for receiving a back rail of a solar panel module. The bracket includes attachment portions with retention tabs and deflection arms that temporarily secure the solar panel module during installation. A wedge clip formed from unibody construction with spaced-apart arms provides securement by passing through aligned openings in the side panels and mounting slots in the back rail. The wedge clip is tapered and compressible, allowing insertion in a compressed state before expanding to create a wedging action that locks the module in place. A mounting portion includes a central bottom hole and alignment projections for attachment to cross bars of fixed tilt systems via mechanical fasteners such as press fit studs, with dumbbell-shaped holes allowing lateral positioning flexibility.

### CROSS-REFERENCE TO RELATED APPLICATIONS

This application claims the benefit of U.S. Provisional Application No. 63/668,046, filed on Jul. 5, 2024. The entire disclosure of the above application is incorporated herein by reference.

### FIELD

The present technology relates to solar energy systems and, more particularly, to mechanisms and methods for mounting solar modules onto mounting rails.

### INTRODUCTION

This section provides background information related to the present disclosure which is not necessarily prior art.

Solar module mounting systems can secure photovoltaic panels while accommodating tracking system requirements and diverse installation conditions. However, certain mounting approaches present several fundamental problems that limit solar installation effectiveness. Installation complexity can create operational challenges. A mounting system requires alignment and manual labor to achieve proper stability and performance, making installation time-consuming and costly. The rigid nature of these systems accelerates mechanical wear, necessitating frequent maintenance to preserve functionality.

Environmental adaptability remains problematic across varying terrain and conditions. Certain systems struggle to accommodate uneven ground while maintaining optimal panel orientation, resulting in reduced energy capture as panels cannot adjust to maximize solar exposure throughout operational cycles. Mechanical reliability issues plague existing clip-based mounting mechanisms. Integration difficulties with tracking technologies compound these problems. Complex mechanisms required for solar tracking functionality are prone to failures and require substantial maintenance investments, limiting practical deployment in cost-sensitive applications.

Accordingly, there is a continuing need for an improved solar module mounting system and method that addresses these challenges and offers enhanced adaptability to various installation environments, case of installation and maintenance including reduced installation time and minimized risk of dislodgement under load, and robust integration with solar tracking technologies.

### SUMMARY

In concordance with the instant disclosure, an improved solar module mounting system and method that offers enhanced adaptability to various installation environments, case of installation and maintenance including reduced installation time and minimized risk of dislodgement under load, and robust integration with solar tracking technologies has surprisingly been discovered.

The present technology includes articles of manufacture, systems, and processes that relate to.

In one embodiment, a solar module bracket for use in mounting a solar panel module in a solar panel installation can include a central panel, a first side panel, and a second side panel that together can form a U-shaped configuration defining a channel that can be configured to receive a back rail of a solar panel module. The central panel can have a length and a width, wherein the central panel can be generally as long as it is wide, which configuration can be determined based on the dimensions of a cross bar of a fixed tilt system where the back rail and cross bar can be generally perpendicular, creating a relatively smaller point of intersection. The first side panel can have an attachment portion that can include a retention tab and an opening, with a deflection arm that can point perpendicular from the retention tab into the channel for temporary securing of the solar panel module. The second side panel can have an attachment portion that can be aligned with the first side panel's attachment portion. A mounting portion can project from the central panel and can include a central bottom hole that can be configured to receive a mechanical fastener and alignment projections that can project downwardly from the central panel, with the alignment projections having a width that can be substantially the same as a width of a dumbbell-shaped hole in a cross bar to allow proper alignment. A wedge clip can be selectively received by the opening of the attachment portion to secure the solar panel module within the bracket.

In another embodiment, a solar panel installation can include a cross bar of a fixed tilt system that can be configured with a dumbbell-shaped hole that can allow for lateral sliding and placement of a solar module bracket along the length of the cross bar. The installation can include a solar module bracket that can be configured with a central panel, first side panel, and second side panel that together can form a U-shaped configuration defining a channel, with the central panel having a mounting portion with a central bottom hole and alignment projections. A mechanical fastener can be disposed through the central bottom hole of the solar module bracket and the dumbbell-shaped hole of the cross bar to couple the bracket with the cross bar. A solar panel module having a back rail with multiple elongate slots can be vertically inserted into the channel of the solar module bracket with deflection arms of attachment portions that can engage with the elongate slots of the back rail to temporarily secure the solar panel module. A wedge clip can be inserted through openings of the solar module bracket and the elongate slots of the back rail to retain the solar panel module within the solar module bracket, providing securement of the installation.

In yet another embodiment a method for mounting a solar panel module in a solar panel installation can include providing a solar module bracket with a central panel, first side panel, and second side panel that together can form a U-shaped configuration defining a channel, with the central panel having a mounting portion with a central bottom hole and alignment projections. The method can include providing a cross bar of a fixed tilt system with a dumbbell-shaped hole that can allow for lateral sliding and placement of the solar module bracket along the length of the cross bar, and providing a mechanical fastener that can be configured to be received by the central bottom hole and the cross bar. The method can include providing a solar panel module having a back rail with multiple elongate slots and providing a wedge clip. The installation process can include positioning the solar module bracket adjacent the cross bar such that the alignment projections can be aligned within the dumbbell-shaped hole, disposing the mechanical fastener through the central bottom hole and dumbbell-shaped hole to couple the bracket with the cross bar, vertically inserting the solar panel module into the channel to engage deflection arms with the elongate slots for temporary securing, and inserting the wedge clip through openings of the bracket and elongate slots of the back rail to retain the solar panel module within the bracket.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a top perspective view of a solar bracket module according to one embodiment of the present invention;

FIG. 2 is a bottom perspective view thereof;

FIG. 3 is a side elevational view thereof;

FIG. 4 is a front elevational view thereof;

FIG. 5 is a top plan view thereof;

FIG. 6 is a perspective view of the solar module bracket shown installed with a solar panel;

FIG. 7 is an exploded perspective view thereof;

FIG. 8 is front elevational view of the solar module bracket shown installed on a crossbar of a fixed tilt system, depicted removed from a solar panel module;

FIG. 9 is a front elevational view of the solar module bracket of FIG. 8, further depicted attached to the solar module bracket;

FIG. 10 is a cross sectional, perspective view of the solar module bracket of FIG. 9;

FIG. 11 is a perspective view of the solar module bracket of FIG. 9, depicted without a wedge clip;

FIG. 12 is a perspective view of the solar module bracket of FIG. 11, depicted with a wedge clip installed;

FIG. 13 is another perspective view of the solar module bracket of FIG. 12;

FIGS. 14A-14B are a flowchart depicting a method of installing the solar module bracket according to one embodiment of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

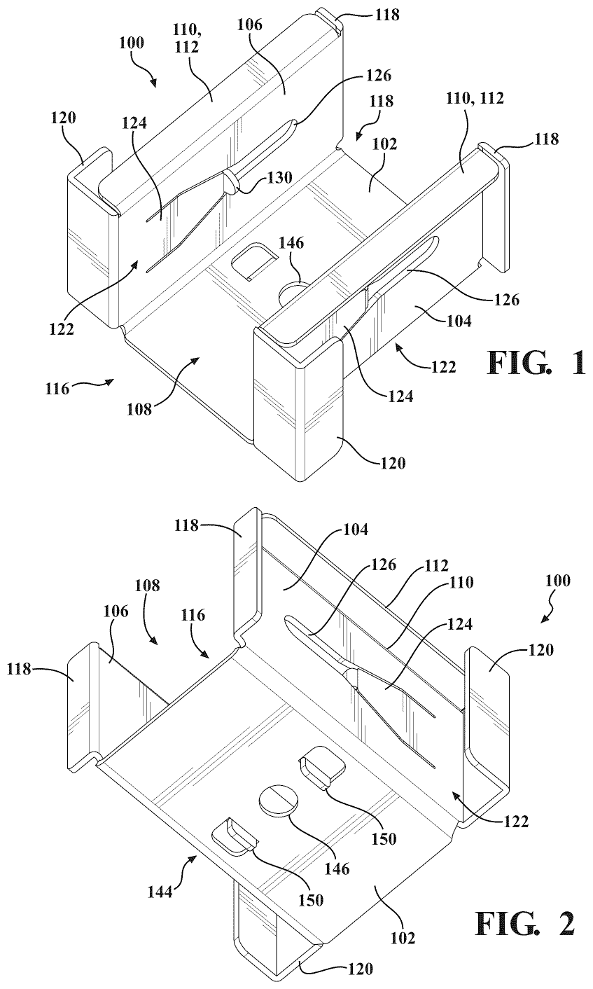

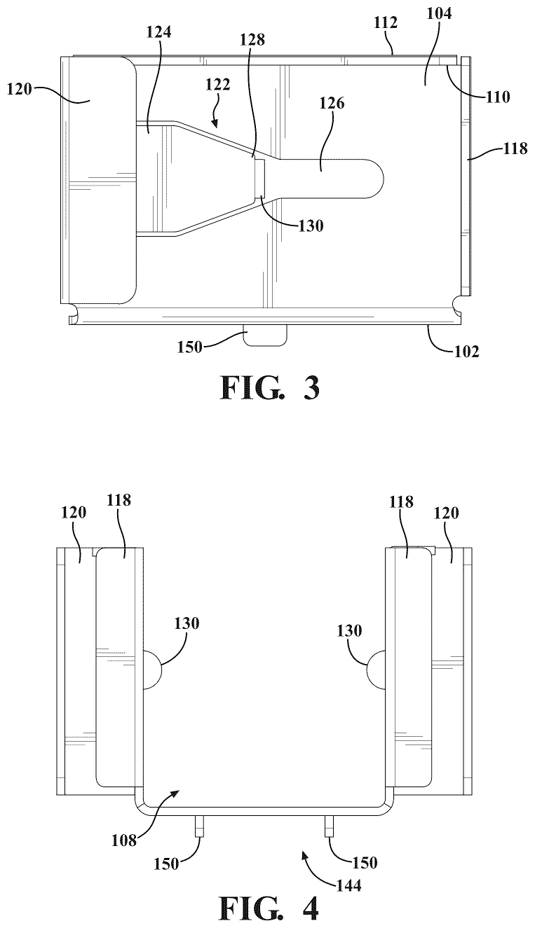

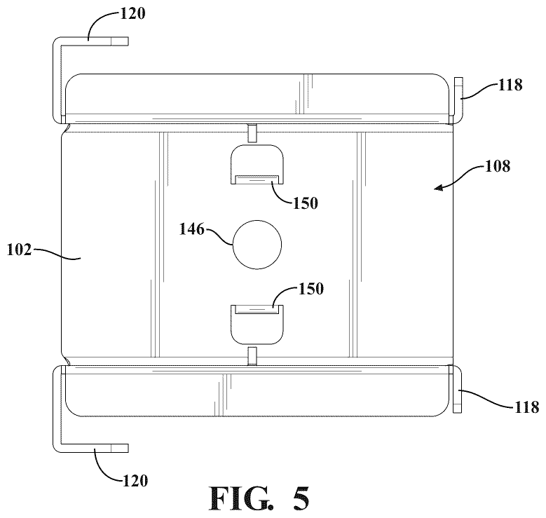

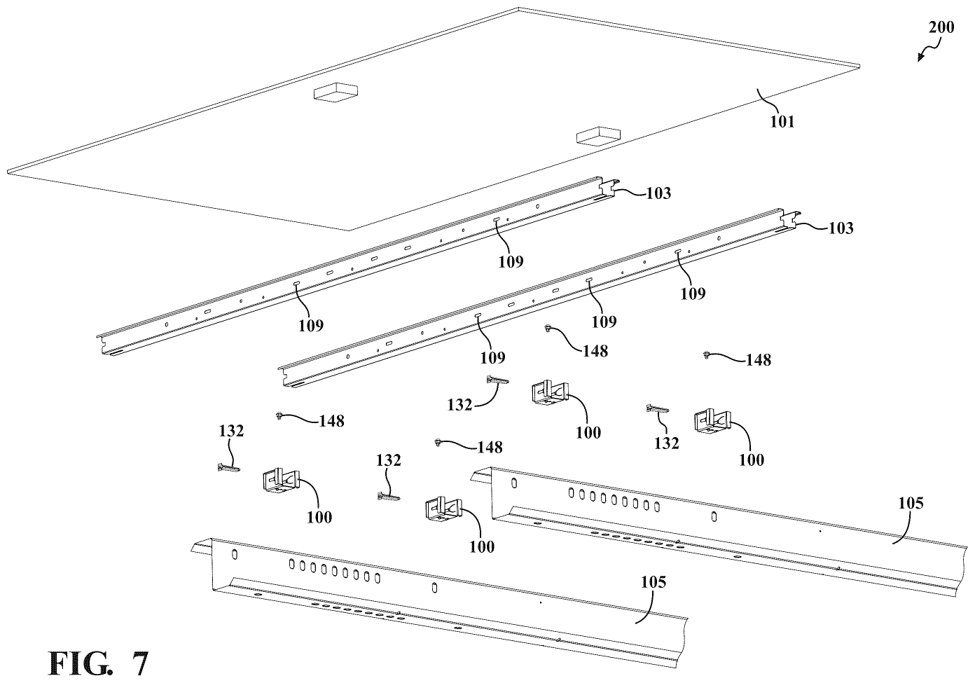

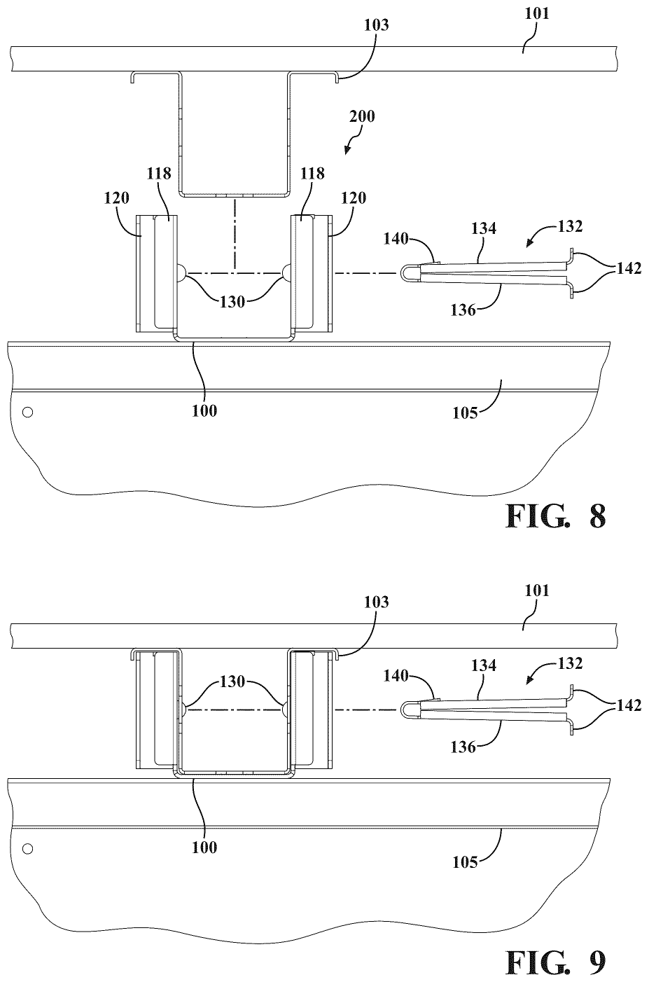

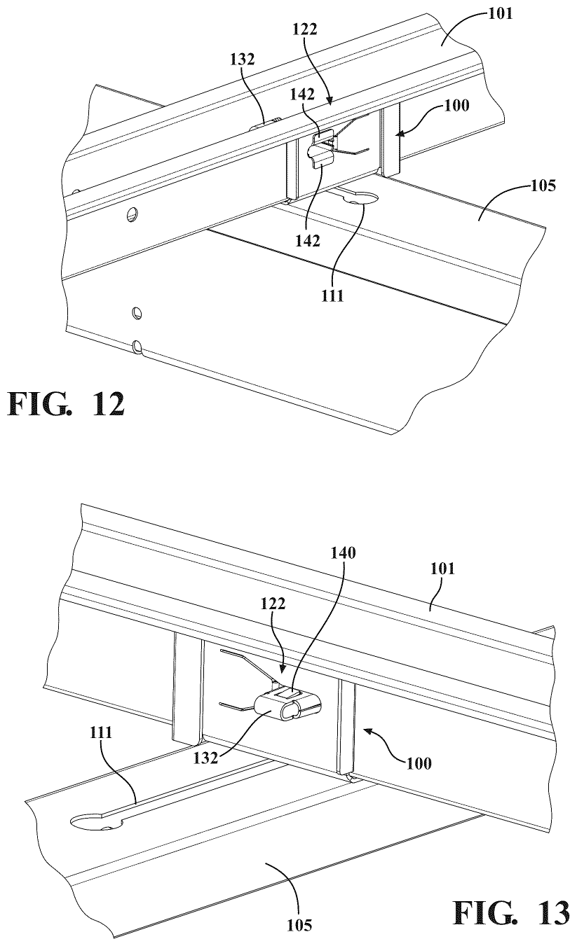

With reference to FIGS. 1-13, a solar module bracket 100 is shown. The solar module bracket 100 can be configured for mounting solar panel modules onto mounting rails in fixed tilt solar panel installations. The solar panel modules can include back rails with multiple elongate slots that facilitate engagement with mounting brackets and hardware. In some embodiments, the elongate slots can be formed through the back rails, which can provide flexibility in positioning and alignment during installation while maintaining secure attachment to the solar module bracket 100. A skilled artisan can select a suitable shape for the elongate slots within the scope of the present disclosure.

The solar module bracket 100 can be constructed from durable materials suitable for continuous exposure to environmental elements encountered in outdoor solar installations. In some embodiments, the solar module bracket 100 can be formed from corrosion-resistant materials that maintain structural integrity and functionality over extended operational periods. The material selection can ensure that the solar module bracket 100 withstands various weather conditions, temperature fluctuations, and environmental stresses while maintaining secure engagement with the back rail of the solar panel module. Additionally, the solar module bracket 100 can be coated with a protective finish to enhance durability and reduce wear from environmental exposure, thereby extending the operational lifespan of the solar module bracket 100.

The solar module bracket 100 can include a central panel 102, a first side panel 104, and a second side panel 106 that together can form a U-shaped configuration. In this U-shaped configuration, the side panels 104, 106 can each extend from an edge of the central panel 102 and can each be disposed along a length of the central panel 102. The central panel 102, first side panel 104, and second side panel 106 can collectively define a channel 108 that can receive a back rail 103 of a solar panel module 101.

The central panel 102 can have a length and a width, wherein the central panel 102 can be generally as long as it is wide. This configuration can be determined based on the dimensions of a cross bar 105 of a fixed tilt system 107, as the back rail 103 and the cross bar 105 can be generally perpendicular, creating a relatively smaller point of intersection to receive the solar module bracket 100. The compact proportions of the solar module bracket 100 can provide optimal support and stability for the solar panel module 103 while accommodating the geometric constraints of the fixed tilt mounting system 107 where the solar module bracket 100 must fit within the limited intersection area between the perpendicular back rail 103 and cross bar 107 components.

Each of the first side panel 104 and the second side panel 106 can have a top edge 110. The top edge 110 of each side panel can have a flange 112. The flange 112 can be perpendicular to the respective side panel 104, 106. The flange 112 can abut a portion of the back rail 103 where the solar module bracket 100 is engaged on the back rail 103 of the solar panel module 101. The flange 112 can help with structural integrity by distributing the weight and mounting forces of the solar panel module 101 across multiple contact points rather than concentrating the load at one particular spot on the side panels 104, 106. The flanges 112 can provide additional bearing surface area that can enhance the overall stability and load distribution of the solar module bracket 100.

The side panels 104, 106 can include a front terminal end 114 and a rear terminal end 116. The front terminal end 114 can have a perpendicular flange 118 extending outwardly therefrom, while the rear terminal end 116 can have a relatively larger L-shaped flange 120 extending outwardly therefrom. The larger L-shaped flange 120 at the rear terminal edge 116 can provide enhanced structural integrity and load-bearing capacity. This asymmetric configuration can optimize load distribution and bearing capacity of the mounting system by creating differentiated contact points between the solar module bracket 100 and the back rail 103 of the solar panel module 101, with the larger rear flange 120 providing additional surface area where greater structural support is needed, thereby reducing stress concentrations at the front terminal end 114 of the central panel 102 while accommodating the specific loading characteristics of the fixed tilt mounting system.

Each of the first side panel 104 and the second side panel 106 can include an attachment portion 122. The attachment portion 122 can be used to secure the solar module bracket 100 in place on the back rail 103 of the solar panel module 101. The attachment portion 122 can include a retention tab 124 and an opening 126. An edge of the retention tab 124 can be cut out from the side panel 104, 106 and at a free end 128 adjacent to the opening 126 there can be a deflection arm 130 that points perpendicular from the retention tab 124 into the channel 108. In operation, the solar module bracket 100 can be placed onto the back rail 103, the back rail 103 can push the deflection arm 130 outwardly from the channel 108, and thereby the retention tab 124 outward from the channel 108, which can be possible since the retention tab 124 can be cut out from the side panel 104, 106. The deflection arm 130 can snap into place into mounting slots 109 on the back rail 103 when the deflection arm 130 is aligned with the mounting slot 109, thereby locking the solar module bracket 100 to the back rail 103.

Each of the first side panel 104 and the second side panel 106 can have an attachment portion 122 that can be aligned with one another. When the back rail 103 can be positioned in the solar module bracket 100, each opening 126 of the attachment portion 122 on the first side panel 104 and the second side panel 106 can be aligned with the mounting slots 109 formed in the back rail 103. As shown in FIGS. 11-12 and 14-16, the aligned openings 126 and mounting slots 109 can receive a wedge clip 132 that can pass through both the openings in the side panels 104, 106 and the mounting slots 109 in the back rail 103 to secure the solar panel module 101 within the solar module bracket 100.

The wedge clip 132 can have dimensions that generally correspond to those of the mounting slot 109 and the openings 124. As such, the wedge clip 132 can have a substantially oval cross section that can match the configuration of the oval slots formed through the back rails 103. This dimensional correspondence can ensure proper fit and engagement when the wedge clip 132 can be inserted through the aligned openings 126 in the side panels and the mounting slots 109 in the back rail 103 to secure the solar panel module within the solar module bracket 100.

The wedge clip 132 can be formed from a unibody construction having a closed end and an open end, where the wedge clip 132 can include a first arm 134 and a second arm 136 that can be integrally connected at the closed end and that can be spaced apart from one another at the open end. Adjacent to the connected end of the wedge clip 132, the first arm 134 can have a spring tab 140 that can extend at an angle outwardly from the first arm 134. The wedge clip 132 can be tapered such that the wedge clip 132 can get wider from the closed end to the open end, creating a gradual increase in cross-sectional area along the length of the wedge clip 132, with a longitudinal split 138, formed by a spacing between the first arm 134 and the second arm 136, increasing along the length of the wedge clip 132. The longitudinal split 138 along the length of the wedge clip 132 can allow the first arm 134 and the second arm 136 of the wedge clip 132 to be compressed together when pressure is applied. When the wedge clip 132 is compressed, the first arm 134 and the second arm 136 can be brought together, effectively closing the longitudinal split 138 and reducing the taper and thereby the overall width of the wedge clip 132 for insertion through the aligned openings 124 and mounting slots 105. During this compression and insertion process, the spring tab 140 can be configured to selectively deform elastically when subjected to compressive forces from the side wall during insertion through the openings 124. The wedge clip 132 can also be self-biased so when the wedge clip 132 is not compressed by the side wall, the wedge clip 132 can automatically return to the tapered shape due to the inherent spring properties of the material and the integral construction of the arms 134, 136 at the closed end, with the first arm 134 and the second arm 136 returning to the spaced-apart positions.

The unibody configuration can allow the wedge clip 132 to be compressed and inserted into the aligned openings 124 and mounting slots 105 in a compressed state, and then once received in the aligned openings 124 and mounting slots 105, the wedge clip 132 can expand back to the tapered configuration to create the wedge action that can secure the wedge clip 132 into the solar module bracket 100. When the spring tab 140 clears the final opening 124, the spring tab 140 can automatically return to an extended configuration due to the inherent elastic properties of the material. Once the spring tab 140 returns to the extended configuration, the spring tab 140 can create a mechanical interference that can militate against withdrawal of the wedge clip 132 through the opening 124 by engaging with the surface of the side panel 104, 106 adjacent to the opening 124. This retention mechanism can provide additional security by militating against inadvertent removal of the wedge clip 132 once the wedge clip 132 has been fully inserted through the aligned openings 124 and mounting slots 105, thereby ensuring permanent securement of the solar panel module 101 to the solar module bracket 100. The spring tab 140 can function as a one-way retention feature that allows insertion but resists extraction, creating a positive locking engagement of the wedge clip 132 in the solar module bracket 100 and the solar panel module 101. The tapered nature of the wedge clip 132 combined with the compressible longitudinal split 138 can provide a secure wedging action that can lock the solar panel module 101 within the solar module bracket 100 by expanding within the aligned apertures once inserted.

On the open side of the wedge clip 132, each end of the first arm 134 and second arm 136 can have retention flanges 142 that can extend substantially orthogonal to each of the first arm 134 and second arm 136. The retention flanges 142 can ensure that the wedge clip 132 can be stopped from being inserted too far through the openings 124 and mounting slots 105. This configuration can allow the wedge clip 132 to move forward enough to engage the spring tab 140, but not substantially further, thus locking the wedge clip 132 in place. The retention flanges 142 can function as insertion stops that can create a mechanical interference with the exterior surfaces of the side panels 104, 106 when the wedge clip 132 reaches the proper insertion depth, thereby militating against over-insertion while ensuring that the retention tab 122 can clear the final opening 124 and spring back to the extended configuration for securement to the solar module bracket 100.

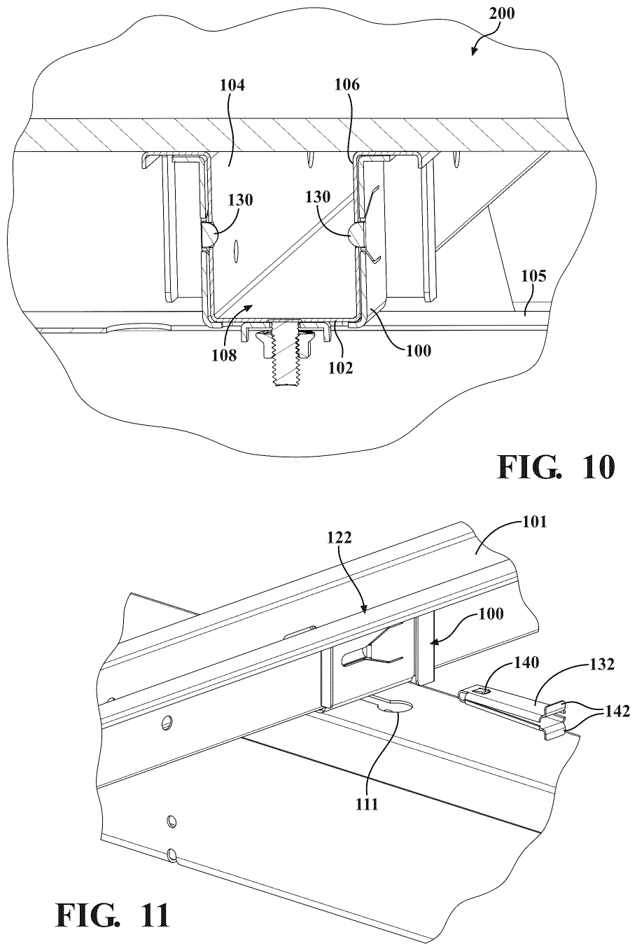

With reference to FIG. 10, the central panel 102 can have a mounting portion 144 that allows the solar module bracket 100 to be mounted to a cross bar 105 of a fixed tilt system 107. The cross bar 105 can feature an elongate dumbbell-shaped hole 111 that allows for lateral sliding and placement of the solar module bracket 100 along the length of the cross bar 105. The elongate dumbbell-shaped hole 111 can be used to connect the solar module bracket 100 to the cross bar 105, providing flexibility in positioning the solar module bracket 100 along the cross bar 105 while maintaining secure attachment through the mechanical fastener. The mounting portion 144 can include a central bottom hole 146 in the bottom wall that is configured to receive a mechanical fastener 148 for securing the solar module bracket 100 to the cross bar 105.

The mounting portion 144 can also include alignment projections 150 that project downwardly from the central panel 102. The alignment projections 150 can have a width that is substantially the same as a width of the elongate middle portion of the dumbbell-shaped hole 111, facilitating the alignment projections 150 to be aligned within the dumbbell-shaped hole 111 to ensure proper positioning of the solar module bracket 100 on the cross bar 105. The alignment projections 150 can ensure that the solar module bracket 100 is centered and aligned on the cross bar 105, while still allowing for the lateral movement along the length of the cross bar 105 via the dumbbell-shaped hole 111 configuration. This lateral movement capability allows installers to slide the solar module bracket 100 laterally to the optimal position where the back rail 103 and cross bar 105 intersect, ensuring proper alignment at each contact point and accommodating variations in solar panel module 101 dimensions and spacing requirements.

As a non-limiting example, the mechanical fastener 148 can be a press fit stud having an upper end substantially flush with the surface of the central panel 102 within the channel 108 The press fit stud configuration can allow the back rail 103 to lay substantially flush or flat against the central panel 102, creating a low-profile mounting assembly that does not protrude significantly into the channel 108 where the back rail 103 is positioned. This flat mounting arrangement can ensure that the back rail 103 can also lay flat within the channel 108 without interference from the mounting hardware, thereby maintaining proper contact between the back rail 103 and the central panel 102 of the solar module bracket 100. The press fit stud can be inserted through the central bottom hole 146 and can engage with the dumbbell-shaped hole 111 in the cross bar 105. A threaded nut or the like can be used with the press fit stud to secure the solar module bracket 100 of the cross bar 105 while maintaining the necessary clearance profile that allows the back rail 103 to be properly seated within the channel 108 without obstruction from the fastening mechanism. This configuration can provide a stable mounting interface between the solar module bracket 100 and the cross bar 105 of the fixed tilt system 107, with the central bottom hole 146 aligning with the dumbbell-shaped hole 111 in the cross bar 105 to accommodate a mechanical fastener such as a bolt and nut. The alignment projections 150 can ensure proper positioning and militate against misalignment of the solar module bracket 100 and the cross bar 105 during installation by fitting within the elongate portion of the dumbbell-shaped hole 111, while the dumbbell-shaped hole 111 configuration can provide flexibility in positioning the bracket along a length of the cross bar 105 while maintaining secure attachment through the mechanical fastener.

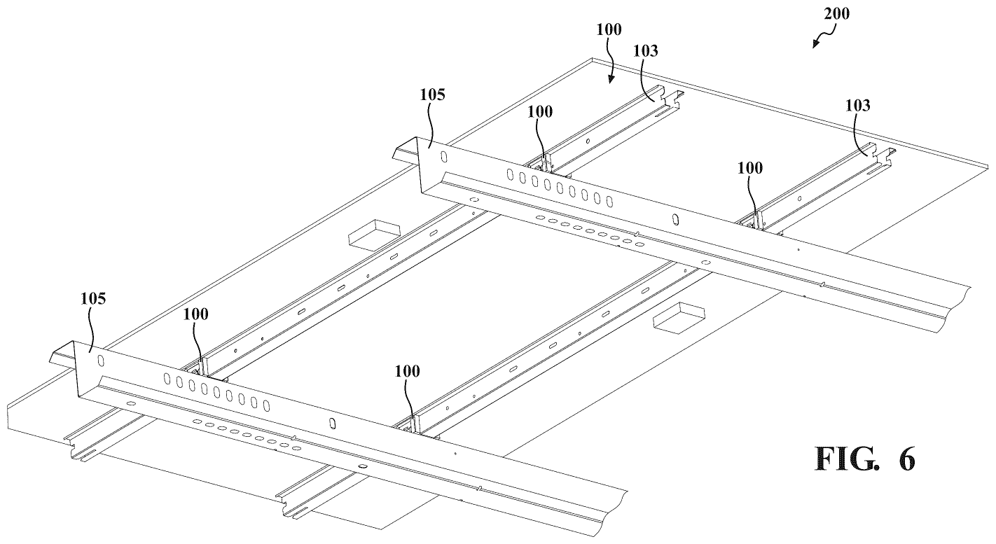

With reference to FIG. 6, a solar panel installation system 200 can include one or more solar module brackets 100. In the installed state, a mechanical fastener can be disposed through the central bottom hole 146 of the solar module bracket 100 and the dumbbell-shaped hole 111 of the cross bar 105, with the alignment projections 150 positioned within the dumbbell-shaped hole 111 to ensure proper alignment of the solar module bracket 100 on the cross bar 105 of the fixed tilt system 107. The back rail 103 can be positioned within the channel 108 of the solar module bracket 100, with the solar panel module 101 having been inserted vertically to engage the attachment portions 122. The deflection arms 130 of the attachment portions 122 can be engaged with mounting slots 109 on the back rail 103, temporarily securing the solar panel module 101 to the solar module bracket 100. The wedge clips 132 can be inserted through the openings 126 of the solar module bracket 100 and the mounting slots 109 of the back rail 103 to secure the solar panel module 101 within the solar module bracket 100. The wedge clips 132 can be formed from a unibody construction with a first arm 134 and a second arm 136 that can be spaced apart and tapered, creating a wedging action when inserted that can lock the solar panel module 101 in place. The spring tabs 140 on the wedge clips 132 can have engaged with the surfaces of the side panels 104, 106 to militate against withdrawal of the wedge clips 132.

Multiple solar module brackets 100 can be installed within the system 200, with the number of brackets 100 determined based on the number of cross bars 105 and the length of the solar module 101. A solar module bracket 100 can be attached at every point where a back rail 103 and a cross bar 105 come into contact. The modular design of the solar module bracket 100 can allow for flexible configuration of solar panel installations 200, where brackets 100 can be positioned at each intersection point between the back rail 103 and cross bar 105 as needed to support the solar panel modules 101. Each solar module bracket 100 can be independently secured to the cross bar 105 using the mechanical fastener and the mounting portion 144 configuration, allowing for precise spacing and alignment of solar panel modules at each back rail and cross bar intersection point. The scalable nature of the system 200 can accommodate various installation sizes, from small residential arrays to large commercial solar farms, by adding solar module brackets 100 at each contact point between back rails 103 and cross bars 105 throughout the fixed tilt system 107.

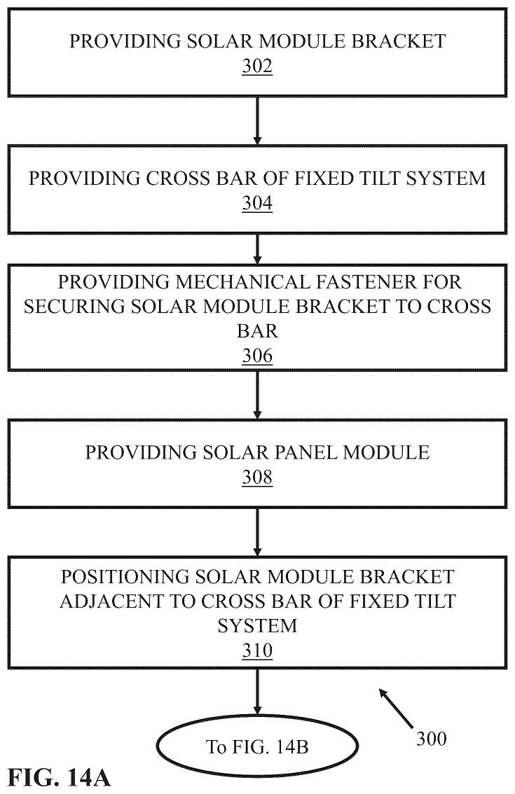

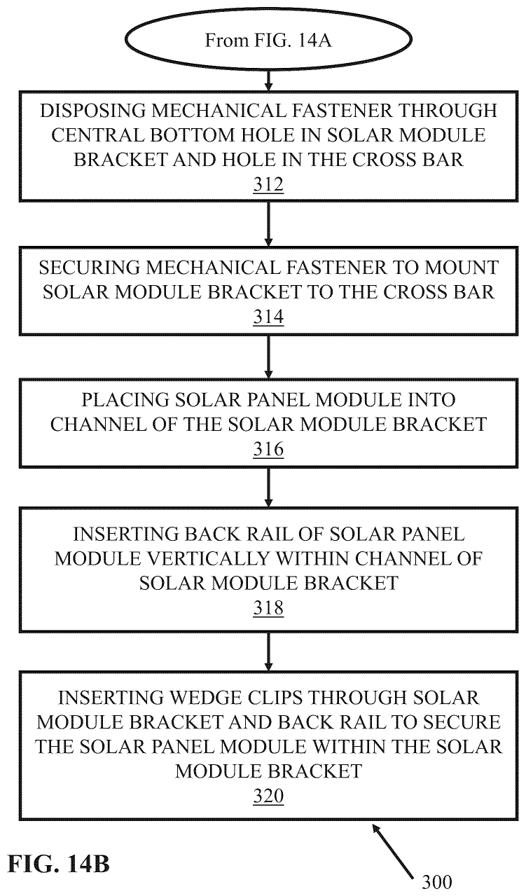

With reference to FIGS. 14, a method 300 of installing the solar module bracket 100 can include a step 302 of providing the solar module bracket 100 having a central panel 102, a first side panel 104, and a second side panel 106 that together can form a U-shaped configuration. The method 300 can include a step 304 of providing a cross bar 105 of a fixed tilt system 107 for mounting the solar module bracket 100. The method 300 can include a step 306 of providing a mechanical fastener for securing the solar module bracket 100 to the cross bar 105 of the fixed tilt system 107. The method 300 can include a step 308 of providing a solar panel module 101 having a back rail 103 with mounting slots 109.

The method 300 can include a step 310 of positioning the solar module bracket 100 adjacent to the cross bar 105 of the fixed tilt system 107 such that the mounting portion 144 that can include the central bottom hole 146 can align with the dumbbell-shaped hole 111 in the cross bar 105, with the alignment projections 150 positioned within the elongate portion of the dumbbell-shaped hole 111. The method 300 can include a step 312 of disposing the mechanical fastener through the central bottom hole 146 in the solar module bracket 100 and through the dumbbell-shaped hole 111 in the cross bar 105. The method 300 can include a step 314 of securing the mechanical fastener to mount the solar module bracket 100 to the cross bar 105 of the fixed tilt system 107.

The method 300 can include a step 316 of placing the solar panel module 101 into the channel 108 of the solar module bracket 100 such that the back rail 103 of the solar module bracket 100 can be positioned within the channel 108. The method 300 can include a step 318 of inserting the back rail 103 of the solar panel module 101 vertically within the channel 108 of the solar module bracket 100 to engage the deflection arms 130 of the attachment portions 122 with the mounting slots 109 on the back rail 103, thereby temporarily securing the solar panel module 101 to the solar module bracket 100.

The method 300 can include a step 320 of inserting wedge clips 132 through the openings 126 of the solar module bracket 100 and the mounting slots 109 of the back rail 103 to secure the solar panel module 101 within the solar module bracket 100. The wedge clips 132 can be compressed during insertion and can expand back to the tapered configuration to create the wedging action that can lock the solar panel module 101 in place, with the spring tabs 140 engaging to prevent withdrawal of the wedge clips 132.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A solar module bracket for use in mounting a solar panel module having a back rail in a solar panel installation, comprising:
a central panel, a first side panel, and a second side panel that together form a U-shaped configuration, wherein the first side panel and the second side panel each extend from an edge of the central panel and are disposed along a length of the central panel, and wherein the central panel, first side panel, and second side panel collectively define a channel;
the first side panel having an attachment portion, wherein the attachment portion includes a retention tab and an opening, wherein an edge of the retention tab is cut out from the first side panel and at a free end adjacent to the opening there is a deflection arm that points perpendicular from the retention tab into the channel;
a mounting portion projecting from the central panel, the mounting portion including a central bottom hole configured to receive a mechanical fastener and alignment projections that project downwardly from the central panel; and
a wedge clip that is selectively received by the opening of the attachment portion.

2. The solar module bracket of claim 1, wherein each of the first side panel and the second side panel has a top edge, and wherein the top edge of each side panel has a flange and each flange is perpendicular to the respective side panel.

3. The solar module bracket of claim 1, wherein the central panel has a front terminal end and a rear terminal end, and the front terminal end has a perpendicular flange extending outwardly therefrom and the rear terminal end has a relatively larger L-shaped flange extending outwardly therefrom.

4. The solar module bracket of claim 1, further comprising an attachment portion on the second side panel that is aligned with the attachment portion of the first side panel.

5. The solar module bracket of claim 4, wherein when the back rail is positioned in the solar module bracket, each opening of the attachment portion on the first side panel and the second side panel is aligned with mounting slots formed in the back rail.

6. The solar module bracket of claim 5, wherein the aligned openings and mounting slots receive the wedge clip that passes through both the openings in the side panels and the mounting slots in the back rail to secure the solar panel module within the solar module bracket.

7. The solar module bracket of claim 1, wherein the wedge clip is formed from a unibody construction, where the wedge clip includes a first arm and a second arm that are spaced apart from one another.

8. The solar module bracket of claim 7, wherein the wedge clip is tapered such that the wedge clip gets wider from one end to the other, creating a gradual increase in cross-sectional area along the length of the wedge clip, with a longitudinal split formed by a spacing between the first arm and the second arm increasing along the length of the wedge clip.

9. The solar module bracket of claim 8, wherein when the wedge clip is compressed, the first arm and the second arm are brought together, effectively closing the longitudinal split and reducing the overall width of the wedge clip for insertion through aligned openings and mounting slots.

10. The solar module bracket of claim 9, wherein the wedge clip is self-biased so when the wedge clip is not compressed, the wedge clip automatically returns to the tapered shape due to inherent spring properties of the material, with the first arm and the second arm returning to spaced-apart positions.

11. The solar module bracket of claim 7, wherein adjacent to a connected end of the wedge clip, the first arm has a spring tab that extends at an angle outwardly from the first arm.

12. The solar module bracket of claim 11, wherein the spring tab is configured to selectively deform elastically when subjected to compressive forces during insertion through the opening, but automatically returns to an extended configuration when the spring tab clears the opening.

13. The solar module bracket of claim 7, wherein on an open side of the wedge clip, each end of the first arm and second arm has retention flanges that extend substantially orthogonal to each of the first arm and second arm.

14. The solar module bracket of claim 1, wherein the mechanical fastener is a press fit stud that lays substantially flush against the central panel to provide clearance for the back rail.

15. A solar panel installation, comprising:
a fixed tilt system having a cross bar with a dumbbell-shaped hole allowing for lateral sliding and placement of a solar module bracket along a length of the cross bar;
a solar module bracket configured with a central panel, a first side panel, and a second side panel that together form a U-shaped configuration defining a channel, the central panel having a mounting portion with a central bottom hole and alignment projections;
a mechanical fastener disposed through the central bottom hole of the solar module bracket and the dumbbell-shaped hole of the cross bar to couple the bracket with the cross bar;
a solar panel module having a back rail with a plurality of elongate slots, wherein the solar panel module is vertically inserted into the channel of the solar module bracket with deflection arms of attachment portions engaging with the elongate slots of the back rail, temporarily securing the solar panel module to the solar module bracket; and
a wedge clip inserted through openings of the solar module bracket and the elongate slots of the back rail to retain the solar panel module within the solar module bracket.

16. The solar panel installation of claim 15, wherein the alignment projections have a width that is substantially the same as a width of the dumbbell-shaped hole, allowing the alignment projections to be aligned within the dumbbell-shaped hole.

17. The solar panel installation of claim 15, wherein the mechanical fastener is a press fit stud that lays substantially flush against the central panel to provide clearance for the back rail.

18. The solar panel installation of claim 15, wherein each of the first side panel and the second side panel has a top edge with a flange that is perpendicular to the respective side panel and abut a portion of the back rail of the solar module.

19. The solar panel installation of claim 15, wherein the central panel has a front terminal end with a perpendicular flange extending outwardly therefrom and a rear terminal end with a relatively larger L-shaped flange extending outwardly therefrom and each of the perpendicular flange and the L-shaped flange abut the back rail of the solar panel module.

20. A method for mounting a solar panel module in a solar panel installation, the method comprising steps of:
providing a solar module bracket with a central panel, a first side panel, and a second side panel that together form a U-shaped configuration defining a channel, the central panel having a mounting portion with a central bottom hole and alignment projections;
providing a cross bar of a fixed tilt system with a dumbbell-shaped hole allowing for lateral sliding and placement of the solar module bracket along a length of the cross bar;
providing a mechanical fastener configured to be received by the central bottom hole of the solar module bracket and the cross bar for securing the solar module bracket with the cross bar;
providing a solar panel module having a back rail with a plurality of elongate slots;
providing a wedge clip;
positioning the solar module bracket adjacent the cross bar such that the alignment projections are aligned within the dumbbell-shaped hole;
disposing the mechanical fastener through the central bottom hole of the solar module bracket and the dumbbell-shaped hole of the cross bar and securing the mechanical fastener to couple the bracket with the cross bar;
vertically inserting the solar panel module into the channel of the solar module bracket to engage deflection arms of attachment portions with the elongate slots of the back rail, whereby the solar panel module is temporarily secured to the solar module bracket; and
inserting the wedge clip through openings of the solar module bracket and the elongate slots of the back rail to retain the solar panel module within the solar module bracket.
